(19) United States
(12) Patent Application Publication
(10) Pub. No.: US 2026/0296065 A1
(43) Pub. Date: Oct. 1, 2026

(54) DRYER, LIQUID DISCHARGE APPARATUS, AND LIQUID DISCHARGE SYSTEM

(71) Applicants: Er Sin KHOO, Kanagawa (JP); Teppei KIKUCHI, Kanagawa (JP); Yuta KOBAYASHI, Tokyo (JP)

(72) Inventors: Er Sin KHOO, Kanagawa (JP); Teppei KIKUCHI, Kanagawa (JP); Yuta KOBAYASHI, Tokyo (JP)

(73) Assignee: Ricoh Company, Ltd., Tokyo (JP)

(21) Appl. No.: 19/556,254

(22) Filed: Mar. 4, 2026

(30) Foreign Application Priority Data
Mar. 28, 2025 (JP) 2025-056831
Dec. 16, 2025 (JP) 2025-256869

(51) Int. Cl. B41J 11/00

(52) U.S. Cl. CPC B41J 11/0022; B41J 11/00216; B41J 11/0024; B41J 11/007

(57) ABSTRACT

A dryer includes: a conveyor including a conveying belt to convey a medium having a printed image on the medium in a conveyance direction; a superheated steam generator to generate a superheated steam; and a nozzle discharger to discharge the superheated steam, generated by the superheated steam generator to the medium conveyed by the conveying belt to dry the printed image on the medium, wherein the conveyor supplies the superheated steam to the conveying belt to heat the conveying belt.

### CROSS-REFERENCE TO RELATED APPLICATIONS

This patent application is based on and claims priority pursuant to 35 U.S.C. § 119(a) to Japanese Patent Application No. 2025-056831, filed on Mar. 28, 2025, in the Japan Patent Office, and Japanese Patent Application No. 2025-256869, filed on Dec. 16, 2025, in the Japan Patent Office, the entire disclosure of which is hereby incorporated by reference herein.

### BACKGROUND

### Technical Field

The present embodiment relates to a dryer, a liquid discharge apparatus, and a liquid discharge system.

### Related Art

There is a medium dryer including a discharger that discharges superheated steam to a medium (exemplary recording medium) and a collector that collects the superheated steam.

However, as a print drying technique, a technique of drying a medium using superheated steam has the following disadvantages. A pressure roller equipped with a heater warms a medium before printing. However, when the medium cools down and passes a superheat portion through which superheated steam is discharged, condensation occurs due to the temperature difference with the surface of the medium at the time of drying using superheated steam. At the time of drying the medium using superheated steam, due to the ambient temperature difference and humidity, the jetted superheated steam causes condensation around a heating device that discharges superheated steam.

### SUMMARY

The present disclosure provides a dryer including: a conveyor including a conveying belt to convey a medium having a printed image on the medium in a conveyance direction; a superheated steam generator to generate a superheated steam; and a nozzle discharger to discharge the superheated steam, generated by the superheated steam generator to the medium conveyed by the conveying belt to dry the printed image on the medium, wherein the conveyor supplies the superheated steam to the conveying belt to heat the conveying belt.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 illustrates an exemplary configuration of an image forming apparatus;

FIG. 2A is a side view of an exemplary dryer in the image forming apparatus;

FIG. 2B is a perspective view of the exemplary dryer in the image forming apparatus;

FIG. 3 is a flowchart illustrating an exemplary flow of warming processing for a conveying belt in the image forming apparatus;

FIG. 4A is an explanatory view for exemplary heat transfer due to opening/closing of a steam collection shutter in the image forming apparatus;

FIG. 4B is an explanatory view for exemplary heat transfer due to opening/closing of the steam collection shutter in the image forming apparatus;

FIG. 5A is an image diagram of a temperature distribution of a recording medium when the conveying belt has a low temperature; and

FIG. 5B is an image diagram of a temperature distribution of a recording medium when the conveying belt includes a mesh belt and has a low temperature in the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An exemplary embodiment of an image forming apparatus to which a dryer, a liquid discharge apparatus, and a liquid discharge system are applied will be described in detail below with reference to the accompanying drawings.

The image forming apparatus warms a conveying belt to reduce the temperature difference with a dried portion of the surface of a recording medium and reduce rises in temperature and humidity using a plurality of ducts in order to prevent condensation due to the temperature difference and humidity around the recording medium (in other words, a printing medium).

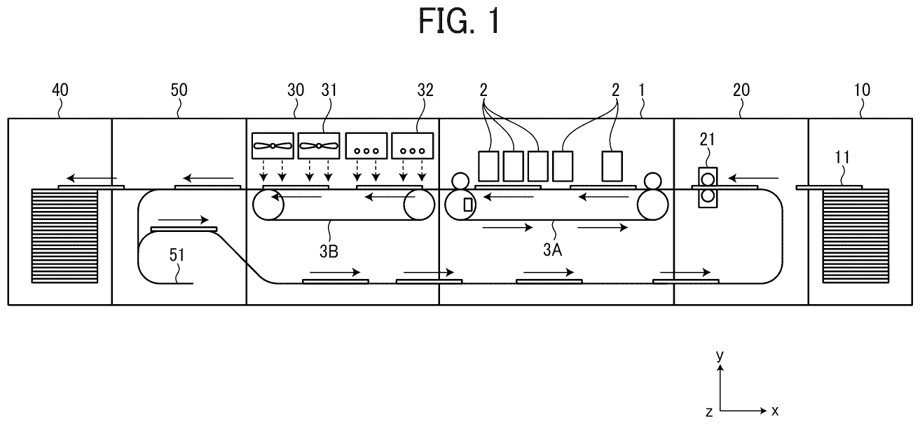

FIG. 1 illustrates an exemplary configuration of an image forming apparatus. In FIG. 1, an x axis represents a direction in which a recording medium, such as a sheet 11, is conveyed. A y axis represents the height direction of the image forming apparatus. A z axis represents the depth direction of the image forming apparatus. The same applies to the drawings following FIG. 1. The image forming apparatus (exemplary liquid discharge apparatus or liquid discharge system) includes an image former 1 including liquid discharge units 2 each including a liquid discharge head that discharges liquid such as ink to a recording medium such as a sheet 11 in an inkjet manner, and a conveying belt 3A that conveys a sheet 11 as a recording medium while holding the sheet 11 on its surface.

In addition, the image forming apparatus includes, on the upstream side in the sheet conveyance direction (conveyance direction of a sheet 11) of the image former 1, a sheet feeder 10 that feeds sheets 11 in a stack and a registration adjuster 20 that performs registration correction on a sheet 11. Furthermore, the image forming apparatus includes, on the downstream side in the conveyance direction of a sheet 11 of the image former 1, a dryer 30 that dries the sheet 11 on which an image is formed in the inkjet manner, a sheet ejector 40 that ejects the dried sheet 11, and a sheet reverse conveyor 50 that reverses the sheet 11 such that a further image is formed on the back face of the sheet 11.

Next, a series of image forming operations of the image forming apparatus for forming an image on a sheet will be described. As illustrated in FIG. 1, first, a sheet 11 is picked up in an individual separation manner from the sheets 11 stacked in the sheet feeder 10. For example, the sheet 11 picked up by an air separator using air is conveyed, toward the image former 1, to the registration adjuster 20 on the downstream side in the conveyance direction.

The sheet 11 conveyed from the sheet feeder 10 reaches the registration adjuster 20. Then, in the registration adjuster 20, the sheet 11 is subjected to registration correction by a registration roller 21 provided inside. The sheet 11 subjected to the registration correction in the registration adjuster 20 is conveyed to the image former 1 at a predetermined timing.

The sheet 11, which is subjected to the registration correction and is conveyed to the image former 1, is conveyed onto the surface of the conveying belt 3A. The conveying belt 3A has an infinite number of air suction holes on its surface and thus can hold the entire sheet 11, by air suction from its back face, in close contact with the surface of the conveying belt 3A. Then, the sheet 11 held, by air suction, in close contact with the surface of the conveying belt 3A is conveyed to the liquid discharge units 2 due to rotation of the conveying belt 3A in the direction of arrows in the drawing.

In the image former 1, the liquid discharge units 2 filled with respective predetermined color inks are disposed in order along the surface of the conveying belt 3A. The sheet 11 held on the surface of the conveying belt 3A is conveyed under each liquid discharge unit 2 for the predetermined color and is subjected to discharging of the corresponding color ink through the nozzles of the liquid discharge head of each liquid discharge unit 2 at a predetermined timing, so that an image is formed on the surface of the sheet 11.

The sheet 11 on which the image is formed by the image former 1 is conveyed onto the surface of a conveying belt 3B that a heating device such as the dryer 30 has. The dryer 30 includes a drying unit 31 and a drying unit 32. The drying unit 32 raises the temperatures of the ink and the sheet 11 in advance using an infrared (IR) heater before the sheet 11 passes the drying unit 31. Then, the sheet 11 passes under the drying unit 31 that dries the sheet 11 using superheated steam, so that the moisture in the ink evaporates. That is, the drying unit 32 includes the IR heater that dries the sheet 11, and the IR heater warms the conveying belt 3B to dry the sheet 11.

The sheet 11 having passed through the dryer 30 is conveyed to the sheet ejector 40, and then is stacked in the sheet ejector 40 in an orderly alignment manner. The dryer 30 is provided with a sheet reverser 51 and a sheet reverse conveyor 50. At the time of double-sided printing, due to the sheet reverser 51 and the sheet reverse conveyor 50, the sheet 11 is reversed and then is conveyed to the image former 1 again. After the sheet 11 has its conveyance direction switched by the sheet reverser 51, the sheet 11 is conveyed toward the image former 1 by the sheet reverse conveyor 50. The sheet 11 is subjected to registration correction by the registration roller 21 before reaching the conveying belt 3A. The sheet 11 subjected to the registration correction is conveyed to the conveying belt 3A and then is held on the surface of the conveying belt 3A with its back face, on which no image is formed, turned up.

Then, in the image former 1, in such a similar manner as described above, an image is formed on the back face with no image of the sheet 11 held on the surface of the conveying belt 3A by the liquid discharge head of each liquid discharge unit 2. Similarly to the time of single-sided printing, the double-sided printed sheet 11 having passed through the dryer 30 is conveyed to the sheet ejector 40 and then the sheet 11 is stacked in the sheet ejector 40 in an orderly alignment manner.

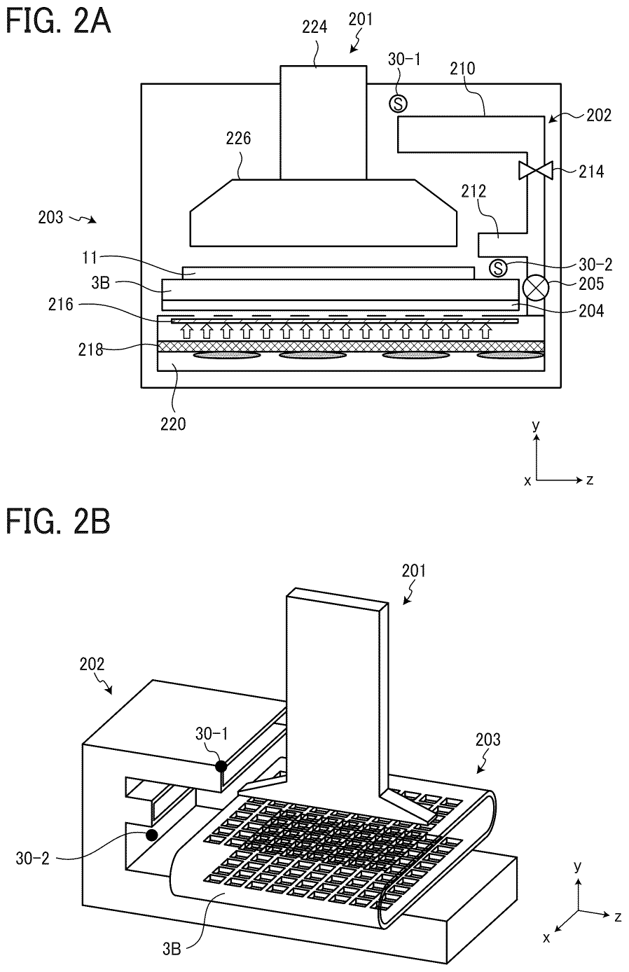

Next, an example of the dryer 30 of the image forming apparatus will be described with FIGS. 2A and 2B. FIG. 2A is a side view of an exemplary dryer of the image forming apparatus. FIG. 2B is a perspective view of the exemplary dryer of the image forming apparatus. The dryer 30 is an exemplary drying apparatus (heating device) that dries a printed image on a recording medium such as a sheet 11 using steam heated to a high temperature (superheated steam). As illustrated in FIG. 2A, the dryer 30 includes a superheated steam generator 201, a nozzle discharger 226, a superheated steam collector 202, and a recording medium conveyor 203.

The superheated steam generator 201 includes a superheated steam generator 224 to generate the superheated steam, the nozzle discharger 226 having jet nozzles to discharge the superheated steam generated by the superheated steam generator 224 from the jet nozzles toward the sheet 11.

The recording medium conveyor 203 is an exemplary conveyor that conveys a recording medium using the conveying belt 3B. The recording medium conveyor 203 includes a heater 204 as an exemplary heater (belt heater) that heats (warms) the conveying belt 3B. Thus, for reduction of condensation from occurring on the surface of a recording medium, the temperature difference between a superheated portion of the surface of the recording medium and the surface portion of the conveying belt 3B can be reduced by warming, so that the surface of the printed image can have an equalized temperature distribution.

Here, the conveying belt 3B of the recording medium conveyor 203 may be exposed to superheated steam in the dryer 30 (superheated steam that the drying unit 31 uses for drying) or the sheet 11 may be directly exposed to the IR heater that the drying unit 32 uses for drying such that the sheet 11 is warmed. The superheated steam collected by the superheated steam collector 202 described later may be applied to the conveying belt 3B to warm the conveying belt 3B. As a specific method for efficiently warming the conveying belt 3B, the quantity of heat of the superheated steam collected by the superheated steam collector 202 is used, so that the power for warming with the heater 204 is reduced. For warming the conveying belt 3B, direct warming due to the heater 204 can be used together with warming due to the collected superheated steam. The heater 204 may be a rod heater. The heater 204 and a superheated steam outlet installed under the heater 204 are disposed without mutual interference. As illustrated in FIG. 2A, the superheated steam outlet installed under the heater 204 may be opened and closed by a slide shutter.

The recording medium conveyor 203 includes a steam source shutter 216 that prevents the conveying belt 3B from being excessively heated. Although warming due to superheated steam is usually on, under on/off (opening/closing) control, the steam source shutter 216 prevents the conveying belt 3B from being excessively heated. The steam source shutter 216 is controlled to be opened or closed to prevent the conveying belt 3B from being excessively heated and to store a certain quantity of heat.

The conveying belt 3B may include a mesh belt. The conveying belt 3B including the mesh belt has a heat insulating effect due to its hollow (air), leading to solution of the disadvantage of condensation on the surface of a recording medium. When the conveying belt 3B has no holes and is cold, at the moment when a quantity of heat is applied to the recording medium such as a sheet 11 using superheated steam, the temperature difference with the recording medium increases since the entire conveying belt 3B is uniformly cold. Thus, the heat of the recording medium is rapidly removed and then the temperature difference with the conveying belt 3B varies rapidly, so that condensation tends to occur on the printed image.

On the other hand, when the conveying belt 3B includes a mesh belt, the conveying belt 3B has a small surface area and air passes easily through the conveying belt 3B, facilitating thermal dispersion. As a result, the temperature difference with the recording medium is not as large as the temperature difference when the conveying belt 3B is cold, and thus condensation can be prevented from occurring on the printed image. When droplets come out from a jet nozzle until superheated steam comes out, a tray may be placed to collect such water. Here, the jet nozzle is a nozzle through which the superheated steam generator 201 jets (discharges) superheated steam.

The superheated steam generator 201 includes a steam collecting fan 205 or a draft and is an exemplary dryer that dries the printed image on the recording medium using superheated steam heated to a high temperature.

The superheated steam collector 202 is an exemplary collector that collects superheated steam. Thus, periodically, condensation can be prevented from occurring around a nozzle discharger 226 that discharges superheated steam in the superheated steam generator 201 and around the superheated steam generator 201. Then, the superheated steam collector 202 also functions as an exemplary dryer that applies the collected superheated steam to the conveying belt 3B to warm the conveying belt 3B. In order to reduce condensation due to the temperature difference around the superheated steam generator 201, the superheated steam collector 202 may perform suction control on the superheated steam around the jet nozzle that discharges superheated steam (exemplary nozzle discharger 226) and on the upstream side of the nozzle discharger 226 in the conveyance direction of the sheet 11. Specifically, in a drying process using superheated steam, the superheated steam collector 202 usually suctions (collects) the superheated steam near the nozzle discharger 226. Based on the humidity detected by a temperature/humidity sensor 30-1, a suction duct 210 is opened by an on-off valve 214 to suction the superheated steam on the upstream side in the conveyance direction such that the humidity around the superheated steam generator 201 is controlled.

As illustrated in FIG. 2A, the dryer 30 includes the temperature/humidity sensor 30-1 and a temperature/humidity sensor 30-2. The temperature/humidity sensor 30-1 is provided near the suction duct 210. The temperature/humidity sensor 30-2 is provided near a suction duct 212. The temperature/humidity sensor 30-1 may detect temperature only, detect humidity only, or detect both thereof. The suction duct 210 may be referred to also as a first suction duct and the suction duct 212 may be referred to also as a second suction duct.

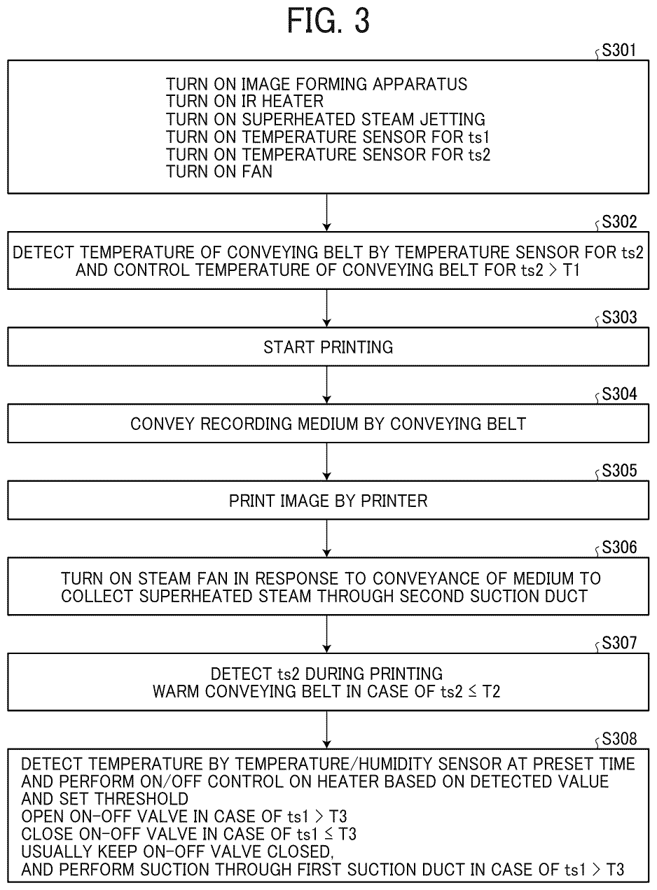

Next, an exemplary flow of warming processing for the conveying belt 3B in the image forming apparatus will be described with FIG. 3. FIG. 3 is a flowchart illustrating an exemplary flow of warming processing for the conveying belt in the image forming apparatus. When the power is turned on, the image forming apparatus turns on the heater 204 of the conveying belt 3B, superheated steam jetting (discharging), a temperature sensor (temperature/humidity sensors 30-1 and 30-2), and the steam collecting fan 205 (step S301).

After the superheated steam discharging starts, the image forming apparatus turns on the steam collecting fan 205 to suction (collect) the superheated steam through the suction duct 212. The collected superheated steam is fed to a storage tank and then the gathered drain is stored in a collection container 220, so that heat is stored above.

The recording medium conveyor 203 includes a water vapor separation membrane 218 to filter the superheated steam in the collection container 220. The water vapor separation membrane 218 selectively permeates water vapor. The water vapor separation membrane 218 is referred to also as “a water vapor trap”.

The temperature sensor detects a temperature ts2 of the conveying belt 3B. Based on the detected temperature ts2 as a result, the image forming apparatus controls the temperature of the conveying belt 3B (step S302). Then, for example, when the temperature ts2 is higher than a threshold T1, the image forming apparatus determines to start printing.

Then, the image forming apparatus starts printing (step S303). The conveying belt 3A conveys a recording medium (step S304), and a printer (image former 1) prints an image on the recording medium (step S305).

In response to conveyance of the medium (recording medium), the image forming apparatus turns on the steam collecting fan 205 to collect the superheated steam through the suction duct 212 (step S306). While the image is being printed on the recording medium, the temperature sensor detects the temperature ts2, and the image forming apparatus warms the conveying belt 3B, based on the detected temperature ts2 (step S307). For example, when the temperature ts2 is not more than a threshold T2, the image forming apparatus turns on warming to the conveying belt 3B. As a method for warming the conveying belt 3B, a method using the quantity of heat of the collected superheated steam or a direct warming method using the heater 204 is used.

The temperature/humidity sensor 30-1 detects a temperature ts1 at a preset time, and the image forming apparatus performs on/off control on the heater 204, based on the detected temperature ts1 and a preset threshold T3 (step S308). For example, when the temperature ts1 is higher than the threshold T3, the image forming apparatus opens the on-off valve 214. For example, when the temperature ts1 is not more than the threshold T3, the image forming apparatus closes the on-off valve 214. Thus, the ambient superheated steam is suctioned through the suction duct 210 to reduce condensation.

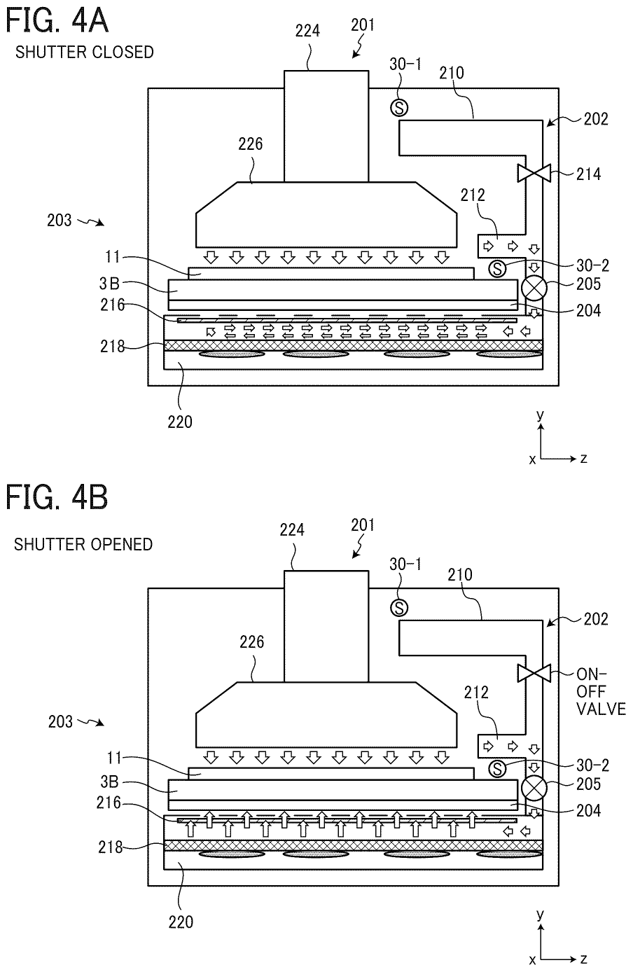

Next, exemplary heat transfer due to opening/closing of the steam source shutter 216 in the image forming apparatus will be described with FIGS. 4A and 4B. FIGS. 4A and 4B are explanatory views for exemplary heat transfer due to opening/closing of the steam source shutter 216 (steam collection shutter) in the image forming apparatus. As illustrated in FIG. 4A, when the steam source shutter 216 (steam collection shutter) is closed, as indicated with arrows, a quantity of heat is stored on the upstream side in the conveyance direction of the sheet 11. When the temperature ts2 detected by the temperature/humidity sensor 30-2 is lower than the threshold T2, the image forming apparatus opens the steam source shutter 216 (steam collection shutter) to release the heat outward such that the conveying belt 3B is warmed. The superheated steam filtered by the water vapor separation membrane 218 flows through the steam source shutter 216 and supplied to the heater 204 and the conveying belt 3B.

According to the image forming apparatus, the quantity of heat of the collected superheated steam can be used for warming the conveying belt 3B and additionally the collected water can be reused for the superheated steam generator 201. Although superheated steam is usually on, the steam source shutter 216 (steam collection shutter) is under on/off (opening/closing) control. Here, the on/off control of the steam source shutter 216 (steam collection shutter) is performed to reduce excessive heating of the conveying belt 3B and store a certain quantity of heat.

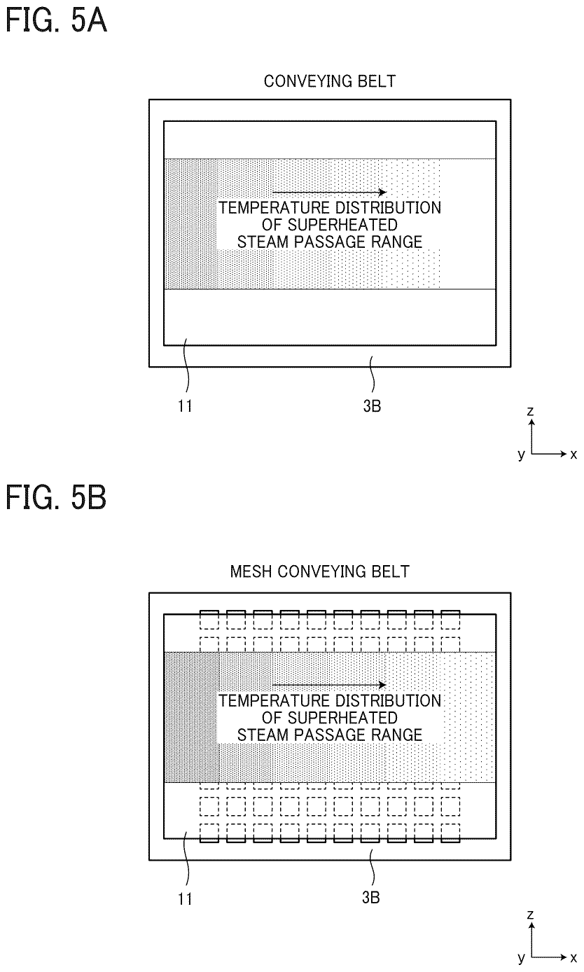

Next, exemplary temperature distributions of a recording medium on the conveying belt 3B in the image forming apparatus will be described with FIGS. 5A and 5B. FIG. 5A is an image diagram of a temperature distribution of a recording medium when the conveying belt 3B has a low temperature. FIG. 5B is an image diagram of a temperature distribution of a recording medium when the conveying belt 3B includes a mesh belt and has a low temperature in the image forming apparatus. As illustrated in FIG. 5A, when the conveying belt 3B has no holes and is cold, at the moment when a quantity of heat is applied to the recording medium using superheated steam, the temperature difference with the recording medium increases since the entire conveying belt 3B is uniformly cold. Thus, the heat of the recording medium is rapidly removed and then the temperature difference varies rapidly, so that condensation tends to occur on the printed image on the recording medium.

On the other hand, as illustrated in FIG. 5B, when the conveying belt 3B includes a mesh belt, the conveying belt 3B has a small surface area and air passes easily through the conveying belt 3B, facilitating thermal dispersion. As a result, the temperature difference between the conveying belt 3B and the recording medium is not as large as the temperature difference when the conveying belt 3B is cold, and thus condensation due to temperature difference can be prevented from occurring on the printed image on the recording medium.

As above, according to the image forming apparatus, warming the conveying belt 3B for a recording medium enables prevention of condensation from occurring on the surface of the recording medium, and periodically suctioning the superheated steam around the nozzle discharger 226 and on the upstream side of the nozzle discharger 226 in the conveyance direction of the sheet 11 enables prevention of condensation from occurring around the heating device, such as the heater 204.

Note that, although the image forming apparatus applied to a multifunction peripheral having at least two functions from a copy function, a printer function, a scanner function, and a facsimile function has been given as an example in the above embodiment, the present embodiment can be applied to any image forming apparatus, such as a copier, a printer, a scanner, or a facsimile machine.

A dryer includes: a conveyor (203) including a conveying belt (3B) to convey a medium (11) having a printed image on the medium (11) in a conveyance direction; a superheated steam generator (224) to generate a superheated steam; and a nozzle discharger (226) to discharge the superheated steam, generated by the superheated steam generator (224) to the medium (11) conveyed by the conveying belt (3B) to dry the printed image on the medium (11), and the conveyor supplies the superheated steam to the conveying belt to heat the conveying belt (3B).

The dryer further includes: a collector (202) to collect the superheated steam; and the conveyor includes a shutter (216) selectively supply the conveying belt (3B) with the superheated steam collected by the collector (202) to heat the conveying belt (3B). The dryer further includes: an infrared heater to: dry the medium; and heat the conveying belt to dry the medium. The conveyor includes a belt heater (204) to heat the conveying belt (3B). The conveying belt includes a mesh belt.

The collector (202) includes: a first suction duct (210) to suction the superheated steam around a nozzle discharger; and a second suction duct (212) to suction the superheated steam above the nozzle discharger.

The collector includes a collection container (220) below the conveying belt (3B), the collection container (220) to store the superheated steam suctioned from the first suction duct (210) and the second suction duct (212), and the shutter (216) is disposed between the conveying belt (3B) and the collection container (220) in a vertical direction intersecting the conveyance direction.

The conveyor includes a sensor (30-2) to detect temperature of the conveying belt (3B), and circuitry configured to open the shutter (216) when the temperature detected by the sensor (30-2) is below a preset threshold (S308).

A liquid discharge apparatus includes: a liquid discharge unit (1) to discharge a liquid onto a medium; and the dryer (30) according to claim 1 to dry the liquid discharged onto the medium by the liquid discharge unit (1).

A liquid discharge system includes: a liquid discharge unit (1) to discharge a liquid onto a medium; and the dryer (30) according to claim 1 to dry the liquid discharged onto the medium by the liquid discharge unit (1).

According to the present embodiment, as an effect, warming a conveying belt for a recording medium enables prevention of condensation from occurring on the surface of the recording medium.

Aspects of the present embodiment are, for example, as follows.

According to Aspect 1, a dryer includes:
a dryer that dries a printed image on a recording medium using superheated steam heated to a high temperature; and
a conveyor that includes a conveying belt that conveys the recording medium and warms the conveying belt using the superheated steam.

According to Aspect 2, in the dryer of Aspect 1, the dryer includes a collector that collects the superheated steam and exposes the conveying belt to the superheated steam collected by the collector to warm the conveying belt.

According to Aspect 3, in the dryer of Aspect 1, the dryer includes an infrared (IR) heater that dries the recording medium and warms the conveying belt using the IR heater to dry the recording medium.

According to Aspect 4, in the dryer of Aspect 1, the conveyor includes a belt heater and warms the conveying belt using the belt heater.

According to Aspect 5, in the dryer of any one of Aspects 1 to 4, the conveying belt includes a mesh belt.

According to Aspect 6, in the dryer of Aspect 2, in order to reduce condensation due to a temperature difference around the conveyor, the collector performs suction control on the superheated steam around a nozzle discharger 226 that discharges the superheated steam heated in the dryer and on an upstream side of the nozzle discharger 226 in a conveyance direction of the recording medium.

According to Aspect 7, a liquid discharge apparatus includes:
a liquid discharge unit that discharges liquid to a recording medium; and
the dryer of any one of Aspects 1 to 6.

According to Aspect 8, a liquid discharge system includes:
a liquid discharge unit that discharges liquid to a recording medium; and
the dryer of any one of Aspects 1 to 6.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A dryer comprising:
a conveyor including a conveying belt to convey a medium having a printed image on the medium in a conveyance direction;
a superheated steam generator to generate a superheated steam; and
a nozzle discharger to discharge the superheated steam, generated by the superheated steam generator to the medium conveyed by the conveying belt to dry the printed image on the medium,
wherein the conveyor supplies the superheated steam to the conveying belt to heat the conveying belt.

2. The dryer according to claim 1, further comprising:
a collector to collect the superheated steam; and
the conveyor includes a shutter selectively supply the conveying belt with the superheated steam collected by the collector to heat the conveying belt.

3. The dryer according to claim 1, further comprising:
an infrared heater to:
dry the medium; and
heat the conveying belt to dry the medium.

4. The dryer according to claim 1,
wherein the conveyor includes a belt heater to heat the conveying belt.

5. The dryer according to claim 1,
wherein the conveying belt includes a mesh belt.

6. The dryer according to claim 2,
wherein the collector includes:
a first suction duct to suction the superheated steam around a nozzle discharger; and
a second suction duct to suction the superheated steam above the nozzle discharger.

7. The dryer according to claim 6,
wherein the collector includes a collection container below the conveying belt,
the collection container to store the superheated steam suctioned from the first suction duct and the second suction duct, and
the shutter is disposed between the conveying belt and the collection container in a vertical direction intersecting the conveyance direction.

8. The dryer according to claim 6,
wherein the conveyor includes a sensor to detect temperature of the conveying belt, and
circuitry configured to open the shutter when the temperature detected by the sensor is below a preset threshold.

9. A liquid discharge apparatus comprising:
a liquid discharge unit to discharge a liquid onto a medium; and
the dryer according to claim 1 to dry the liquid discharged onto the medium by the liquid discharge unit.

10. A liquid discharge system comprising:
a liquid discharge unit to discharge a liquid onto a medium; and
the dryer according to claim 1 to dry the liquid discharged onto the medium by the liquid discharge unit.
